(19) United States
(12) Patent Application Publication
(10) Pub. No.: US 2008/0010177 A1
(43) Pub. Date: Jan. 10, 2008

(54) Income Tax Revenue Generator

(76) Inventor: Larry D. Hansen, Salt Lake City, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/456,514

(22) Filed: Jul. 10, 2006

(51) Int. Cl. G07F 19/00

(52) U.S. Cl. 705/31

(57) ABSTRACT

A system and method by which additional income revenue is identified and paid to a taxing authority without any direct cost to the taxing authority. In particular, the government or taxing authority empowers by contract or by other arrangement a contracting control entity to oversee the audit of entities or companies to identify income tax compliance. The contracting control entity may utilize the services of contracted licensed CPAs and/or tax attorneys to conduct audits. To the extent the audits identifies avoided and/or unpaid taxes, the avoided or unpaid taxes are paid. The contracting control entity is only compensated if additional income tax revenue is paid and then the contracting control entity receives a percentage thereof. The CPAs and tax attorney are paid pursuant to contract.

### BACKGROUND

1. Field of the Invention

The present invention relates to a system and method for the collection of income taxes. More particularly, the present invention contemplates having any taxing authority, such as the Treasury Department or Internal Revenue Service of the United States Government, contract with and empower an auditing and tax collection control entity such that the control entity would have the power to audit business entities, individuals, or any other entities to identify unpaid income taxes. The control entity and any of its subcontractors or agents would be compensated by receiving a percentage of any additional income taxes collected.

2. Background of the Invention and Related Art

Tax laws mandate that individuals and entities pay income taxes according to the rules and regulations promulgated by the tax authority. In particular, income tax must be paid by those entities who have revenue income and whose obligation to pay taxes is not excused.

In some instances, persons or entities make monthly or quarterly tax payments. In other situations, persons or entities withhold taxes and pay them from time to time. In other instances, the employers of individuals withhold taxes and likewise pay the taxes. In each case, it is the duty of the taxpaying person or entity to ensure that they have paid the appropriate amount of income tax without taking inappropriate exemptions or deductions. Above all, the obligated persons or entities must ultimately pay various tax obligations.

For example, as a check on who is properly and may be avoiding taxes, the Internal Revenue Service of the United States Government (IRS) periodically audits persons or entities as a way of spot-checking or, if the IRS has reason to suspect, determining whether the person or entity has failed to pay its income tax obligation. The IRS has limited human and financial resources to carry out this immensely burdensome task of regulating and policing the payment of income tax.

It is estimated that the United States government fails to collect billions of dollars of income taxes because persons or entities have not paid taxes, avoided paying taxes, or have not paid the appropriate amount of tax under the IRS rules and guidelines. As a result, the United States government is deprived of billions of dollars of revenue which it could otherwise have available to it to fulfill its many government purposes and services.

Part of the problem is that the IRS is short-handed and cannot with its limited human resources adequately police the populace of the United States both business, personal, or other entities in order to determine whether all collectible or all taxes due to the United States have been paid. A number of efforts have been made to increase the collection of different types of taxes.

U.S. Pat. No. 5,875,433 issued Feb. 23, 1999 teaches and discloses a point of sales tax reporting and automatic collection system. It includes a smart tax register located at a retail location. The retailers smart register processes consumer transactions and calculates the amount of sales tax due the retailer by the consumer for each transaction. Following the transaction, the consumer requests and is given a tax paid receipt. Either immediately or periodically, the register forwards the amount of the transaction and the amount of sales tax collected by the retailer to a computer and memory at a remote location under state government taxing authority. This addresses only sales tax.

U.S. Pat. No. 6,016,479 issued Jan. 18, 2000, is directed to a system for recovering tax revenue. One implementation is to recover tax revenue currently not being recovered by storing data in a database indicating interstate sales transactions on which a seller does not collect the designated tax such as the sales tax. The database is part of a computer network which organizes and stores the data in the database and automatically sends out tax due notices to purchasers when data in the database indicates that an interstate sale has taken place and no designated tax has been collected from the purchaser by the seller. Again, this system contemplates the recording of information for the collection of sales tax monitoring and payment.

U.S. Pat. No. 6,898,573, issued May 24, 2005, is directed to a system which ensures the timely payment of taxes due a taxing authority while protecting the solvency of an independent service provider. The contracting entity retains a third-party as escrow manager who oversees payments made by the contracting entity to an independent service provider. The third-party escrow manage estimates tax liability owed by the independent service provider to a tax authority based upon data provided to a third-party escrow manager by the independent service provider. This system contemplates a third-party escrow manager in whose control of an escrow account is used for the immediate collection of taxes.

U.S. Pat. No. 6,993,502 issued Jan. 31, 2006, is directed to a system and method for computing and collecting taxes. The system computes and collects sales and use taxes consistent with legal guidelines and restrictions imposed by national governments such as the United States. The system is useful for computing and collecting taxes on Internet sales.

Published United States Patent Application No. US2003/0144930 A1, published Jul. 31, 2003, is directed to a method for managing tax audit information for a business entity using a server system. The server system is coupled to a centralized database and at least one client system. Next, it includes receiving at the server system tax audit information from the client system storing tax audit information received at the server system in a centralized database, tracking tax audit information stored in the central database, updating the centralized database periodically with newly received tax audit information to maintain tax audit information, and providing tax audit information in response to an inquiry. This system is used in connection with sales tax revenue related to Internet sales.

Published United States Patent Application No. US2003/011377 A1, is directed to a method for facilitating whistle blowing by members of the public and individuals within public and private entities who learn of fraud or other misconduct perpetrated by or upon such entities. An organization is established that accepts anonymous tips and information about misconduct, but maintains the contact with the anonymous reporter. When sufficient information is in hand, the organization approaches the entity doing or suffering the misconduct. The organization offers to provide the information in order that corrective action, and stopping the polluting discharge to avoid a fine or stopping certain misconduct ensuing to collect damages can be taken by the entity. A reward is agreed upon, together with a time that it will be paid in any contingencies in this award. A portion of the reward plus a service fee to the organization is paid to the reporter or a third-party as designated by the reporter or the organization.

Published United States Patent Application No. US2005/0216351 A1, is directed to a tax revenue collection system, in which tax revenue losses to electronic commerce are collected. Tax revenue lost from electronic commerce generally arises because electronic commerce enables a significant increase in remote sales, thereby causing a shift from collecting sales taxes at the point of sale to collecting use tax in the state. This application deals with the monitoring and collection of sales taxes.

Published United States Patent Application No. US2005/0228729 A1, issued Oct. 13, 2005, is directed to a system and method for analyzing tax avoidance of a tax paying entity. A tax paying entity's financial information may be analyzed and used to compute a set of one or more financial ratios based at least in part on the entities return on assets, capital, sales, and/or operating expenses. Those ratios may be compared to corresponding ratios formulated firms operating in a predefined market to identify whether the tax paying entity engages in tax avoidance. This system sets up standards or norms to compare one entity to another in the hopes of identifying tax liability that needs to be adjusted.

Published United States Patent Application No. US2006/0026086 A1, published Feb. 2, 2005, is directed to a business method that provides industry-specific education programs and industry-specific professional service programs having a predefined contractual relationship with at least one entity. The contractual relationship has terms whereby the business delivers the industry specific education program and the industry-specific professional services program to the entity in response to a receipt of the value of the entity. Both the industry specific education program and the industry specific professional services program are based on industry classification system defining occupations and tax classifications with an industry segment of an industry sector core. An audit service is used for tax audit abatement identification.

None of the foregoing systems or methods provide additional human resources, audit capability, and/or tax collection ability to the tax authority in helping to recover unpaid or avoided income taxes. The present invention contemplates making available to a taxing authority skilled, trained, financial and tax professionals who need no training, no office space, no physical or financial resources, or other auditing assistance from the taxing authority, but provide such to the government at no direct cost to the taxing authority. Use of tax professionals to perform such audits may increase the desire of persons or entities to be complaint to current tax law.

As a result, the avoided or uncollected income taxes remain avoided or unpaid unless revealed by a competent audit.

### SUMMARY OF THE INVENTION

The present invention is directed to providing a taxing authority, such as the Untied States Government, at no direct cost to the taxing authority, experts trained in the field of auditing, reviewing, analyzing, scrutinizing the taxes paid by persons or entities to identify avoided or uncollected income taxes. A control entity contracts with the taxing authority and receives auditing and tax collection authority. The contracting control entity or control entity is compensated with a percentage of collected, additional income tax.

As a gatekeeper, the control agency manages, certifies, and/or controls subcontractors previously identified as experience in tax matters and those who can provide tax audit, tax analysis, tax identification, and other tax auditing services. Such subcontractors are licensed CPAs or tax attorneys who can perform compliance audits authorized by the control entity. The licensed CPAs and tax attorneys need no training from the taxing authority, need no office space from the taxing authority, need no equipment or other service equipment, need no transportation or per diem allotments, and are not paid a salary. In short, the licensed CPAs and tax attorneys utilized by the control entity perform the audits without being paid a salary or direct compensation by the taxing authority.

The control entity, the licensed CPAs and tax attorneys are only compensated when avoided or unpaid taxes are identified and collected; the control entity would receive an agreed upon portion of the additional tax collected. The Control Entity would pay the licensed CPAs and tax attorney according to contract. In this way, there is no additional obligation of the taxing authority to fund further tax compliance audits. The control entity and its related licensed CPAs and tax attorneys are skilled in their tax audit abilities and are incentivized to be efficient, and are only compensated if additional tax is collected such that no direct costs for the compliance audits is borne by the taxing authority.

This unique and novel system and method is not contemplated by the prior art. The method and system of the present invention meets the need of the taxing authority to conduct additional tax compliance audits and permits the taxing authority to have compliance tax audits performed for the taxing authority at no direct cost to the taxing authority.

These and other features, aspects, and advantages of the inventive methods and systems will be apparent to those skilled in the art in the following detailed description of preferred illustrative embodiments taken together with the drawing and claims that follow.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawing. Understanding that the drawing depicts only a typical embodiment of the present invention and is not, therefore, to be considered as limiting the scope of the invention, the present invention will be described and explained with additional specificity and detail through the use of the accompanying drawing in which:

Referring to the drawing, the following should be noted:

FIG. 1 is a sketch or flow diagram of illustrative component parts of the novel and unique tax identification and collection methods and systems of the present invention.

### DETAILED DESCRIPTION OF THE PREFERRED EMBODIMENTS

It will be readily understood that the components of the present invention, as generally described and illustrated in the figure herein, could be arranged and designed in a wide variety of different configurations. Thus, the following more detailed description of the embodiments of the system and method of the present invention is not intended to limit the scope of the invention, as claimed, but is merely representative of the presently preferred embodiments of the invention.

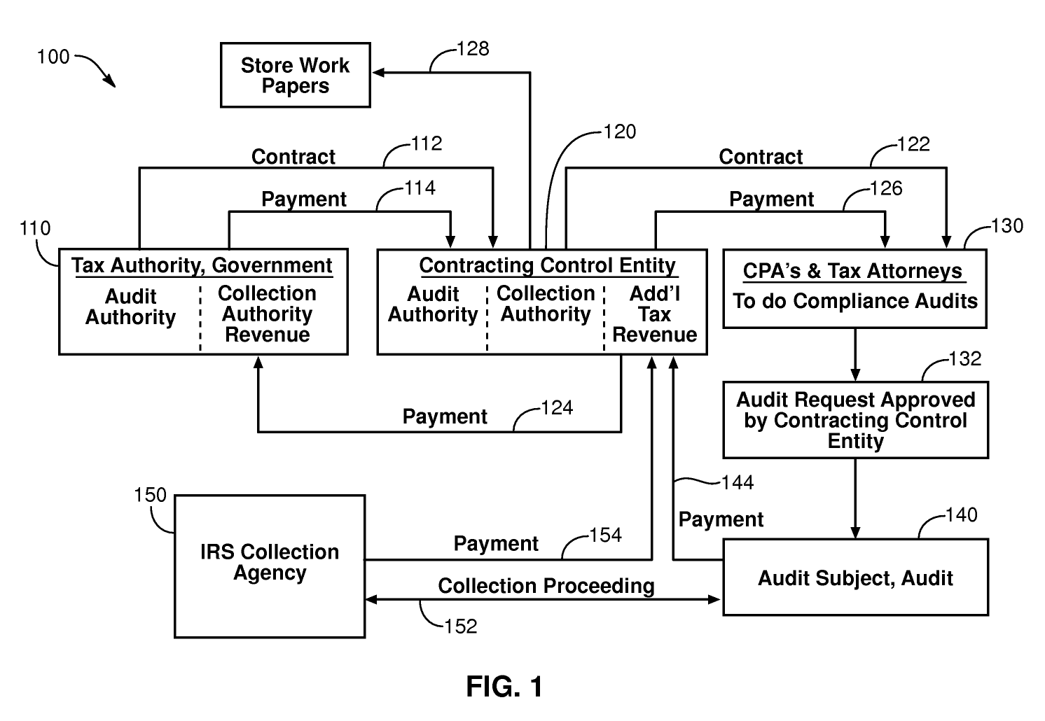

The income tax identification and collection system and methods 100 of the present invention are illustrated in FIG. 1. Several primary players are involved, namely, the taxing or government authority 110, the contracting control entity 120, the licensed CPAs and tax attorneys 130 and the audit subject 140. It may be necessary to involve a collection agency 150.

The taxing or government authority 110 is by way of example a government such as the United States Government. It could also be a government agency, department, or state government which collects income tax. The taxing or government authority has at least two powers. First, it has the power to regulate the obligation to pay income taxes including an audit authority. It also has the power to collect the income taxes. The specifics and details of income tax auditing and collections is not set forth herein but is known by those skilled in the art.

In the present system and method, the taxing authority or government 110 enters into a contract 112 with a contracting control entity 120. Contract 112 empowers contract control entity 120 and its agents to exercise the income tax audit and collection authority of the taxing authority or government 110. This could be done either contractually or in the form of an agency as illustrated by other types of privatizing that governments such as the United States Government has done.

In turn, contract control entity 120 contracts 122 with licensed CPAs and tax attorneys 130. These CPAs and tax attorneys are already or can quickly become skilled in and knowledgeable of the tax laws of the taxing authority. Professionals 130 need no training by the taxing authority, they need no offices or equipment provided by the taxing authority. They need no oversight by the taxing authority. Such licensed CPAs and tax attorneys 130 are persons already skilled in the art of conducting tax audits or knowing what is typically needed for tax compliance.

The licensed CPAs and tax attorneys 130 make a request 132 to the contract controlling entity 120 for permission to audit an identified person or entity. The contact control entity 120 acts as a gatekeeper as to who will and will not be audited. Contracting control entity 120 ensures that a particular large or deep pocket corporation is not overrun with audit requests and that CPAs and tax attorneys do not conduct unauthorized audits. Upon receiving approval from contracting control entity 120, the licensed CPAs and tax attorneys 130 then conduct an audit of the identified audit subject 140.

The licensed CPAs and/or tax attorneys 130 use their skills to identify what types of taxes the audit subject 140 should pay, and then has the skills and analytical ability to identify whether such taxes were paid, in what amount, and whether the audit subject 140 is in compliance with its tax obligations. It is contemplated that the audit of the audit subject 140 by a licensed CPA and/or tax attorneys 130 will reveal that the audit subject 140 is in compliance or is not in compliance with its income tax obligations. If it is not, and additional avoided or unpaid taxes are identified, then the audit subject is required to make payment of the avoided or unpaid tax.

Audit subject 140 makes payment of the identified, avoided or unpaid tax 144 to the contracting control entity 120. In turn, contracting control entity 120 makes payment of the identified avoided or unpaid tax 124 to the taxing authority or government 110. Thereafter, the taxing authority or government 110 makes a payment 114 to the contracting control entity 120. It is contemplated that payment 114 would be an agreed upon percentage or amount of the identified and collected additional tax from the audit subject 140.

Depending upon the terms of contract 112 between taxing authority 110 and contracting control entity 120, it is contemplated that payment 114 may not be necessary if contracting control entity 120 is permitted to withhold its compensation from payment 124.

In the event that avoided or unpaid taxes are identified and the audit subject 140 refuses to make payment 144 to the contract control entity 120, it may be necessary to utilize the services of the IRS or a collection agency 150. This may result in a collection proceeding 152. If such a proceeding is initiated and if the IRS or a collection agency is successful in obtaining additional income taxes from the audit subject, then the IRS or collection agency 150 could make a payment 154 to the contract control entity similar to payment 144. Thereafter, the contracting control entity 120 would make payment 124 to the taxing authority 110.

It is contemplated that the contracting control entity 120 may generate and/or the licensed CPAs and tax attorneys 130 may generate or obtain information, including confidential information of audit subject 140. The present invention contemplates that the contracting control entity 120 and licensed CPAs and tax attorneys 130 would be obligated to maintain any confidential information of the audit subject 140 and retain copies of the files in either physical or electronic form in some type of storage of work papers 128.

The present invention contemplates that contract 112 between the taxing authority 110 and the contracting control entity 120 would spell out general guidelines regarding what audit subjects may or may not be audited. For example, companies currently under audit by the IRS would not be audited without written permission by the IRS. All proposed audits and all proposed audit subjects would be screened by the contracting control entity 120 consistent with contract 112.

Contracting control entity 120 and licensed CPAs and attorneys 130 would comply with all professional and best practices guidelines, including but not limited to any types of conflict determinations to ensure that the audits conducted by the licensed CPAs and/or tax attorneys 130 are consistent with the applicable tax law and obligations.

Utilizing this system and methods of empowering the contract control entity 120 and its contracted licensed CPAs and/or tax attorneys 130, taxing authority such as the United States Government, State governments or any other taxing authority is provided with skilled, trained, equipped and professional manpower to identify avoided or unpaid taxes without direct cost to the taxing authority. Using the systems methods of the present invention, it is contemplated that hundreds of millions or billions of dollars of additional income tax revenue will become available to taxing authority without any upfront or direct cost for identifying the avoided or unpaid taxes.

As stated herein the incentive compensation to the contracting control entity 120 and its licensed CPAs and/or tax attorneys 130 is the agreed upon and contracted compensation set forth in contract 112. In this way, contract control entity 120 and the licensed CPAs and/or tax attorneys 130 are only compensated if additional taxes are identified and paid. In this way, the taxing authority obtains additional income tax revenue without cost or without increasing its manpower or resources.

What is claimed:

1. A system for identifying and collecting avoided or unpaid income taxes comprising:
a taxing authority empowering a contracting control entity with income tax audit and collection authority;
conducting an income tax compliance audit of an audit subject to identify any previously avoided or unpaid taxes; and
requiring the previously avoided or unpaid income taxes to be paid.

2. The system of claim 1 further comprising collecting the previously unpaid income taxes.

3. The system of claim 2, wherein collection of the previously avoided or unpaid tax is made by payment to the contract control entity.

4. The system of claim 2 further comprising payment of an amount of the previously unpaid income taxes to the contracting entity as compensation.

5. The system of claim 1 wherein the avoided or unpaid tax is made to the taxing authority.

6. The system of claim 1, wherein the contracting control entity contracts services of licensed CPAs and/or tax attorneys to conduct the income tax audit.

7. A method of identifying unpaid income taxes for a taxing authority, the method comprising:
empowering a contract control entity with the income tax audit and collection authority of the taxing authority;
conducting an income tax audit of an audit subject to identify any previously avoided or unpaid income taxes; and
obligating the audit subject to pay the previously avoided or unpaid income tax.

8. The method of claim 7 further comprising collecting the previously avoided or unpaid income tax.

9. The method of claim 8, wherein collecting the previously avoided or unpaid income tax is made by payment to the contracting control entity.

10. The method of claim 8 further comprising paying an amount of the previously avoided or unpaid income taxes to the contracting control entity as compensation.

11. The method of claim 7 wherein collecting the previously avoided or unpaid tax is made by payment to the taxing authority.

12. The method of claim 7 wherein the contracting control entity contracts services of licensed CPAs and/or tax attorney(s) to conduct the income tax audit.

13. A method of collecting unpaid income taxes, the method comprising:
identifying a tax authority empowered to audit for and collect income taxes;
empowering a contract control entity with the income tax audit and collection authority of the taxing authority;
conducting an income tax audit of an audit subject to identify any previously avoided or unpaid income taxes; and
obligating the audit subject to pay the previously avoided or unpaid income tax.

14. The method of claim 13 further comprising collecting the previously avoided or unpaid income tax.

15. The method of claim 14, wherein collecting the previously avoided or unpaid income tax is made by payment to the contracting control entity.

16. The method of claim 14 further comprising paying an amount of the previously avoided or unpaid income taxes to the contracting control entity as compensation.

17. The method of claim 13 wherein collecting the previously avoided or unpaid tax is made by payment to the taxing authority.

18. The method of claim 13 wherein the contracting control entity contracts services of licensed CPAs and/or tax attorney(s) to conduct the income tax audit.
